(19) United States
(12) Patent Application Publication
(10) Pub. No.: US 2016/0023151 A1
(43) Pub. Date: Jan. 28, 2016

(54) ONE TYPE OF WALL-MOUNTED AIR PURIFIER

(71) Applicant: Broan Building Products (Huizhou) Co., Ltd., Huizhou (CN)

(72) Inventors: Stephen Kells Swenerton, Boulder, CO (US); He Zhijun, Hartford, WI (US)

(21) Appl. No.: 14/738,282

(22) Filed: Jun. 12, 2015

(30) Foreign Application Priority Data
Jun. 12, 2014 (CN) 201420313921.9

(51) Int. Cl. B01D 46/00; B01D 46/42; B01D 46/44

(52) U.S. Cl. CPC B01D 46/0023; B01D 46/0036; B01D 46/442; B01D 46/0005; B01D 46/4254; B01D 46/429; B01D 46/008

(57) ABSTRACT

The present utility model relates to an air purifier, in particular to an air purifier for hanging directly on a wall. To overcome the inadequacies or existing air purifiers in being unable to effectively absorb dust in high-level air indoors and taking up a user's usable space, the present utility model provides an indoor air purifier. The air purifier comprises a box assembly, an air output reversal device, an air outlet grid, a frame assembly, a basic-efficiency filter, a high-efficiency filter, a panel assembly and a wall fixing plate. The air purifier can be hung directly on a wall, can not only effectively absorb pollutants such as dust in high-level air, but also save usable indoor space for a user.

### TECHNICAL FIELD

The present utility mode relates to an air purifier, in particular to an air purifier for hanging directly on a wall.

### BACKGROUND ART

At present, most known indoor air purifiers have a tabletop or standing structure, and must be arranged on a table or floor during use. However, large amounts of dust in indoor air, including partly respirable particles (commonly called PM10) and very fine particulates (commonly called PM2.5), are suspended in high-level air indoors due to the effect of buoyancy. Respirable particles and very fine particulates are collectively referred to as particulates, a term which can be abbreviated as dust. The purifying effect of conventional tabletop or standing air purifiers on such dust is limited. Moreover, conventional tabletop or standing air purifiers must be arranged on a table or floor, taking up usable indoor space, and causing great inconvenience.

### CONTENT OF THE INVENTION

In order that the present invention can overcome the inadequacies of existing air purifiers in being unable to effectively absorb dust in high-level air indoors and taking up a user's usable space, the present utility model provides an indoor air purifier which can be hung directly on a wall, and which can not only effectively absorb pollutants such as dust in high-level air, but also save a user's indoor space.

To solve the above technical problem, the present utility model employs the following technical solution:

An air purifier for hanging directly on a wall, the air purifier comprising a box assembly which houses a wind wheel, an air output reversal, device, an air outlet grid, a frame assembly, a high-efficiency filter, a basic-efficiency filter and a panel assembly; the frame assembly comprises an air inlet frame and an air outlet frame; an air inlet is formed between the panel assembly and the air inlet frame; the panel assembly comprises a panel air outlet; the air purifier also comprises a wall fixing plate, by means of which wall fixing plate the box assembly can be hung directly on a wall. The wind wheel is also called a motor.

The air inlet refers to a gap provided between the panel assembly and air inlet frame; there is no need to specially provide an opening in the panel as an air inlet.

Furthermore, in the air purifier described above, the air inlet frame, high-efficiency filter, basic-efficiency filter and panel assembly are disposed at an air intake end of the wind wheel; the air output reversal device is installed at an air output end of the wind wheel, an air output end of the air output reversal device corresponds to the air outlet grid, the air outlet grid is installed on the air outlet frame, and the air outlet frame corresponds to the panel air outlet.

During operation of the air purifier described above, dirty indoor air enters the box assembly through the air inlet between the panel assembly and frame assembly under the sucking action of the wind wheel, is filtered by the basic-efficiency filter and high-efficiency filter in sequence, and then fresh air is discharged via the air cutout reversal, device, air outlet grid and panel air outlet.

Due to dimension requirements and structural limitations of the product described above, the positions of the air inlet and air outlet in the present application are an optimized design.

The maximum blowing rate of the air purifier described. above is 200 cmh (cubic meters per hour), the maximum noise volume is 41 db (decibels) , and the energy consumption/power is 25 Watts.

Furthermore, in the air purifier described above, the panel assembly is fixed to the frame assembly by means of a rotation shaft and a holding magnet; the holding magnet rule can be opened, and the panel, assembly can be opened by unilaterally rotating the rotation shaft on the other rule, in order to conveniently replace the filters behind the panel assembly.

Furthermore, in the air purifier described above, the basic-efficiency filter is of nylon material, while the high-efficiency filter is formed of a combination of high-density composite paper and activated carbon.

Furthermore, in the air purifier described above, the air purifier further comprises plastic wall plugs and fixing plate screws; the plastic wall plugs are first struck into a wall, then the fixing plate screws are used to fix the wall fixing plate to the wall; lastly, the box assembly is hung on the wall fixing plate.

Furthermore, in the air purifier described above, the panel assembly is movably installed and fixed on the frame assembly by means of a rotation shaft and a holding magnet; when a filter is to be replaced or cleaned, the panel assembly can be removed from the frame assembly.

Furthermore, in the air purifier described above, the panel assembly is movably installed and fixed on the frame assembly by means of a holding magnet; when a filter is to be replaced or cleaned, the panel assembly can be removed from the frame assembly.

Furthermore, in the air purifier described above, protruding hanging hooks are disposed on the wall fixing plate, and the box assembly comprises a bottom face, on which bottom face are disposed recessed hanging slots capable of being fixed on the protruding hanging hooks.

Furthermore, 4 protruding hanging hooks are disposed on the wall fixing plate, while 4 recessed hanging slots are disposed on the bottom face of the box assembly.

Furthermore, in the air purifier described above, the air purifier comprises a sensor for measuring a particulate concentration in air; when the particulate concentration exceeds a certain value, the sensor is able to automatically turn on the wind wheel, and when the particulate concentration falls to a certain value, the sensor is able to automatically turn off the wind wheel.

Furthermore, in the air purifier described above, the air purifier comprises an indicator lamp, the indicator lamp comprising a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

When the air purifier is operating in the first running mode, the wind wheel runs at high speed, and the blowing rate of the air purifier is high. When the air purifier is operating in the second running mode, the wind wheel runs at low speed, and the blowing rate of the air purifier is low. When it is not necessary to use the air purifier to purify indoor air, the air purifier must be turned off manually; after manual turn-off, the wind wheel gradually stops running.

The particulate concentration value when the air purifier described above begins to operate may be set according to a user's requirements. The particulate concentration value when the air purifier described above stops operating may be set according to the user's requirements.

Furthermore, the air purifier comprises a remote controller, the remote controller comprising a manual mode and an automatic mode; when the remote controller is in the automatic mode, the sensor automatically begins to operate.

The remote controller described above may be used to set a product usage time; a user may set this time manually according to a local pollution level. The more serious the local pollution level, the shorter the set usage time should be. Once the set usage time has expired, the red signal lamp in the air purifier begins to flash, to prompt the user to replace the high-efficiency filter. The usage time is the usage time of the high-efficiency filter in the air purifier.

Furthermore, the air purifier described above further comprises a main control circuit board; the main control circuit board is used for receiving signals transmitted by the sensor, and turning the wind wheel on or off according to the signals transmitted by the sensor.

Furthermore, in the air purifier described above, the high-efficiency filter comprises an electronic indicating means, for indicating whether the high-efficiency filter has been installed properly; once installation of the high-efficiency filter is complete, the electronic indicating means transmits a signal to the main control circuit board, and the main control circuit board puts the air purifier into a state in which the latter is able to operate.

Compared with the prior art, the air purifier provided by the present utility model can be hung directly on a wall, can not only effectively absorb pollutants such as dust in high-level air, but also save usable indoor space for a user, and is convenient to use.

### DESCRIPTION OF THE ACCOMPANYING DRAWINGS

FIG. 1 is a schematic diagram of the structure of the air purifier provided by the present utility model;

FIG. 2 is a schematic diagram of the installation of the air purifier provided by the present utility model;

FIG. 3 is a schematic diagram of the internal structure of the air purifier provided by the present utility model, and an airflow diagram;

FIG. 4 is a structural schematic diagram showing how the bottom face of the box assembly of the air purifier provided by the present utility model is fixed to the wall fixing plate.

In the figures: 1 is the box assembly, 2 is the air output reversal device, 3 is the air outlet grid, 4 is the frame assembly, 5 is the high-efficiency filter, 6 is the basic-efficiency filter, 7 is the panel assembly, 8 is the fixing plate screw, 9 is the wall fixing plate, 901 is the protruding hanging hook, 10 is the plastic wall plug, 11 is the wall, 101 is the wind wheel, 102 is the bottom face of the box assembly, 1021 is the recessed hanging slot, 401 is the air-inlet frame, 402 is the air outlet frame, 701 is the air inlet, 702 is the panel air outlet, 100 is dirty air, 200 is fresh air.

### PARTICULAR EMBODIMENTS

The technical solution of the present utility model is explained further below in conjunction with the accompanying drawings and embodiments.

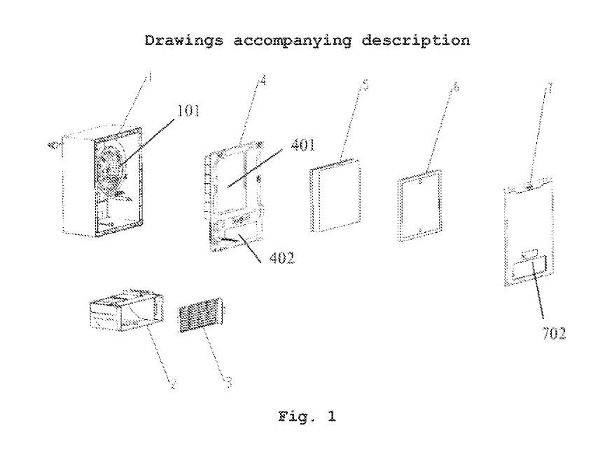

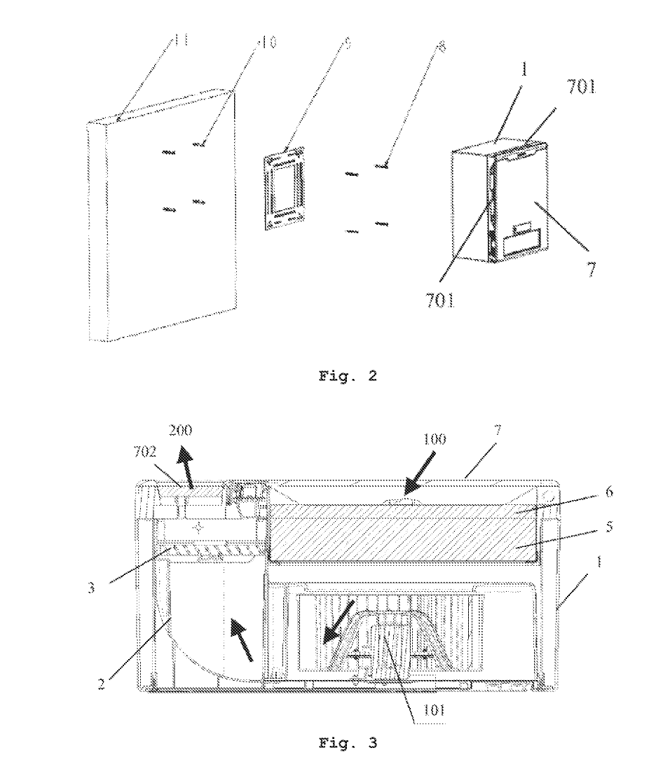

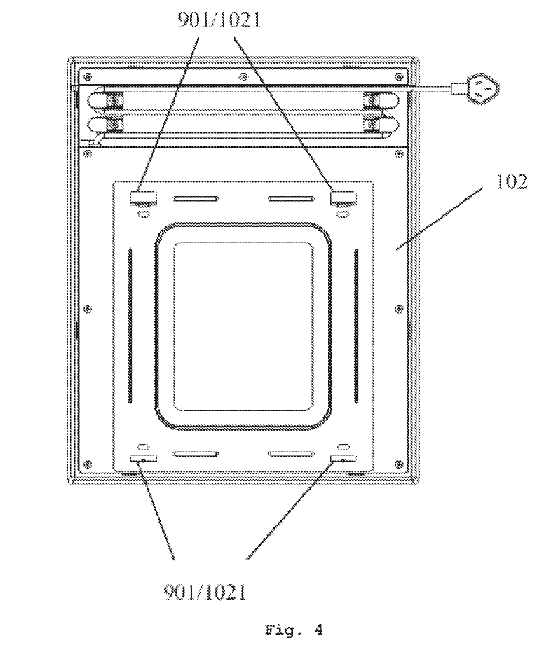

As FIGS. 1, 2, 3 and 4 show, the present utility model provides an air purifier, comprising a box assembly 1 which houses a wind wheel 101, an air output reversal device 2, an air outlet grid 3, a frame assembly 4, a high-efficiency filter 5, a basic-efficiency filter 6 and a panel assembly 7 The frame assembly 4 comprises an air inlet, frame 401 and an air outlet frame 402. An air inlet 701 is formed between the panel assembly 7 and the air inlet frame 401. The panel assembly 7 comprises a panel air outlet 702. The air purifier also comprises a wall fixing plate 9, by means of which wall fixing plate 9 the box assembly 1 can be hung directly on a wall. Protruding hanging hooks 901 are disposed on the wall fixing plate 9, and the box assembly 1 comprises a bottom face 102, on which bottom face 102 are disposed recessed hanging slots 1021 capable of being hung on the protruding hanging hooks 901.

The air inlet frame 401, high-efficiency filter 5, basic-efficiency filter 6 and panel assembly 7 are disposed at an air intake end of the wind wheel 101. The air output reversal device 2 is installed at an air output end of the wind wheel 101, an air output end of the air output reversal device corresponds to the air outlet grid 3, the air outlet grid 3 is installed on the air outlet frame 402, and the air outlet frame 402 corresponds to the panel air outlet 702.

During operation of the air purifier described above, ditty indoor air 100 enters the box assembly 1 through the air inlet 701 between the panel assembly 7 and frame assembly 4 under the sucking action of the wind wheel 101, is filtered by the basic-efficiency filter 6 and high-efficiency filter 5 in sequence, and then fresh air 200 is discharged via the air output reversal device 2, air outlet grid 3 and panel air outlet 702.

The panel assembly 7 is fixed to the frame assembly 4 by means of a rotation shaft and a holding magnet; the panel assembly 7 can be opened by opening the holding magnet rule and unilaterally rotating the rotation shaft on the other rule, in order to conveniently replace the filters behind the panel assembly 7.

The air purifying function of the product is mainly realized through two-stage filtration by two filter elements. Indoor air first passes through the basic-efficiency filter 6, which is of nylon material and mainly filters fine hair, hairs and large-radius suspended particles; the air then passes through the high-efficiency filter 5, which is formed of a combination of high-density composite paper and activated carbon. The high-density composite paper mainly filters very fine particulates in indoor air; the activated carbon can adsorb harmful gases. The basic-efficiency filter 6 can be washed in water and used repeatedly; the high-efficiency filter 5 must be replaced periodically to guarantee the purification effect.

The air purifier further comprises plastic wall plugs 10 and fixing plate screws 8. The plastic wall plugs 10 are first struck into a wall 11, then the fixing plate screws 8 are used to fix the wall fixing plate 9 to the wall. Lastly, the box assembly 1 is hung on the wall fixing plate 9.

The air purifier described above comprises a sensor for measuring a particulate concentration in air; when the particulate concentration exceeds a certain value, the sensor is able to automatically turn on the wind wheel, and when the particulate concentration falls to a certain value, the sensor is able to automatically turn off the wind wheel.

The air purifier described above comprises an indicator lamp, the indicator lamp comprising a red signal lamp and a blue signal lamp, and the sensor is able to control the indicator lamp. When the particulate concentration detected by the sensor reaches a certain value, the air purifier begins to operate in a first running mode, and the red signal lamp on the air purifier lights up; when de particulate concentration is lower than a certain value, the air purifier begins to operate in a second running mode, and the blue signal lamp lights up. The blue signal lamp remains lit until the air purifier begins to operate in the first running mode again.

The particulate concentration value when the air purifier described above begins to operate may be set according to a user's requirements. The particulate concentration value when the air purifier described above stops operating may be set according to the user's requirements.

When the air purifier is operating in the first running mode, the wind wheel runs at high speed, and the blowing rate of the air purifier is high. When the air purifier is operating in the second running mode, the wind wheel runs at low speed, and the blowing rate of the air purifier is low. When it is not necessary to use the air purifier to purify indoor air, the air purifier must be turned off manually; after manual turn-off, the wind wheel gradually stops running.

The air purifier described above comprises a remote controller, the remote controller comprising a manual mode and an automatic mode. When the remote controller is in the automatic mode, the sensor automatically begins to operate.

The air purifier described above further comprises a main control circuit board; the main control circuit board is used for receiving signals transmitted by the sensor, and turning the wind wheel on or off according to the signals transmitted by the sensor.

The high-efficiency filter described above comprises an electronic indicating means, for indicating whether the high-efficiency filter has been installed properly; once installation of the high--efficiency filter is complete, the electronic, indicating means transmits a signal to the main control circuit board, and the main control circuit board puts the air purifier into a state in which the latter is able to operate.

The embodiments above are merely preferred embodiments of the present invention, which are not intended to define the scope of protection thereof. All equivalent changes and modifications made according to the content of the present invention shall be included in the patent scope thereof.

1. Air purifier for hanging directly on a wall, characterized in that the air purifier comprises a box assembly which houses a wind wheel, an air output reversal device, an air outlet grid, a frame assembly, a high-efficiency filter, a basic-efficiency filter and a panel assembly; the frame assembly comprises an air inlet, frame and an air outlet frame; an air inlet is formed between the panel assembly and the air inlet frame; the panel assembly comprises a panel air outlet; the air purifier also comprises a wall fixing plate, by means of which wall fixing plate the box assembly can be hung directly on a wall.

2. Air purifier according to claim 1, characterized in that the air inlet, frame, high-efficiency filter, basic-efficiency filter and panel assembly are disposed at an air intake end of the wind wheel; the air output reversal device is installed at an air output end of the wind wheel, an air output end of the air output reversal device corresponds to the air outlet grid, the air outlet grid is installed, on the air outlet frame, and the air outlet frame corresponds to the panel air outlet.

3. Air purifier according to claim 1, characterized in that the panel assembly is fixed to the frame assembly by means of a rotation shaft and a holding magnet; the holding magnet rule can be opened, and she panel assembly can be opened by unilaterally rotating the rotation shaft on the other rule, in order to conveniently replace the filters behind the panel assembly.

4. Air purifier according to claim 1, characterized in that the basic-efficiency filter is of nylon material, while the high-efficiency filter is formed of a combination high-density composite paper and activated carbon.

5. Air purifier according to claim 1, characterized in that the air purifier further comprises plastic wall plugs and fixing plate screws; the plastic wall plugs are first struck into a wall, then the fixing plate screws are used to fix the wall fixing plate to the wall; lastly, the box assembly is hung on the wall fixing plate.

6. Air purifier according to claim 1, characterized in that the panel assembly is movably installed and fixed on the frame assembly by means of a rotation shaft and a holding magnet; when a filter is to be replaced or cleaned, the panel assembly can be removed from the frame assembly.

7. Air purifier according to claim 1, characterized in that the panel assembly is movably installed and fixed on the frame assembly by means of a holding magnet; when a filter is to be replaced or cleaned, the panel assembly can be removed from the frame assembly.

8. Air purifier according to claim 1, characterized in that protruding hanging hooks are disposed on the wall fixing plate, and the box assembly comprises a bottom face, on which bottom face are disposed. recessed hanging slots capable of being fixed on the protruding hanging hooks.

9. Air purifier according to claim 1, characterized in that the air purifier comprises a sensor for measuring a particulate concentration in air; when the particulate concentration exceeds a certain value, the sensor is able to automatically turn on the wind wheel, and when the particulate concentration falls to a certain value, the sensor is able to automatically turn off the wind wheel.

10. Air purifier according to claim 9, characterized in that the air purifier comprises an indicator lamp, the indicator lamp comprising a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

11. Air purifier according to claim 9, characterized in that the air purifier comprises a remote controller, the remote controller comprising a manual mode and an automatic mode; when the remote controller is in the automatic mode, the sensor automatically begins to operate.

12. Air purifier according to claim 9, characterized in that the air purifier comprises a main control circuit board; The main control circuit board is used for receiving signals transmitted by the sensor, and turning the wind wheel on or off according to the signals transmitted by the sensor.

13. Air purifier according to claim 12, characterized in that the high-efficiency filter comprises an electronic indicating means, for indicating whether the high-efficiency filter has been installed properly; once installation of the high-efficiency filter is complete, the electronic indicating means transmits a signal to the main control circuit board, and the main control circuit board-outs the air purifier into a state in which the latter is able to operate.
